(19) United States
(12) Patent Application Publication
(10) Pub. No.: US 2026/0030827 A1
(43) Pub. Date: Jan. 29, 2026

(54) 3D OBJECT GENERATION WITH TEXT-BASED TEXTURE ALIGNMENT

(71) Applicant: NVIDIA Corporation, Santa Clara, CA (US)

(72) Inventors: Tianshi CAO, Toronto (CA); Karsten Julian KREIS, Vancouver (CA); Nicholas Mark Worth SHARP, Seattle, WA (US); Kangxue YIN, Toronto (CA); Sanja FIDLER, Toronto (CA)

(73) Assignee: NVIDIA Corporation, Santa Clara, CA (US)

(21) Appl. No.: 18/781,492

(22) Filed: Jul. 23, 2024

(51) Int. Cl. G06T 15/04; G06T 15/20; G06T 17/00

(52) U.S. Cl. CPC G06T 15/04; G06T 15/20; G06T 17/00

(57) ABSTRACT

Various examples, systems, and methods are disclosed relating to texture synthesis. A first computing system determine, using a denoiser and based at least on an input indicating one or more characteristics of a scene, a plurality of estimated views of the scene corresponding to a texture. The first computing system can render, from a model of the texture, a plurality of renders of the texture, at least one render of the plurality of renders being associated with a corresponding estimated view of the plurality of estimated views. The first computing system can update the model of the texture based at least on the plurality of renders and the plurality of estimated views. The first computing system can update the plurality of estimated views based at least on the plurality of renders.

### BACKGROUND

Generating high-quality textures for three-dimensional (3D) models presents many significant challenges. Texture data, which is used for accurate and realistic rendering, is often generated through separate and disjointed processes, leading to inefficiencies and increased computational demands. This separation requires frequent data manipulation and processing, which is resource-intensive and prone to errors, especially under conditions involving complex geometries and multiple view perspectives. The inherent technical difficulty in maintaining texture consistency and fidelity across various views further complicates the generation process. These challenges affect the effectiveness of systems in producing high-quality textures, impacting the accuracy and efficiency of texture rendering in real-time or near real-time environments.

### SUMMARY

Implementations of the present disclosure relate to the generation and optimization of textures for three-dimensional (3D) models. In contrast to conventional systems, which exhibit limitations in efficiently generating high-quality textures that are consistent across multiple views, the systems and methods described herein can address these limitations through integrated denoising, rendering, and/or optimization techniques. This implementation provides more accurate and resource-efficient texture synthesis. For example, the systems and methods can initialize and denoise particles that represent views of an object and/or scene, render textures from a model of the object and/or scene, and iteratively optimize the textures to ensure high fidelity and consistency. Furthermore, by combining these processes and reducing or eliminating the need for separate data manipulation, the computing systems and methods can maintain reliable texture generation even in the presence of complex geometries and multiple view perspectives. This provides improved systems and methods for generating and optimizing textures for 3D models across diverse applications.

At least one implementation relates to one or more processors. The one or more processors can include one or more circuits. The one or more circuits can determine, using a denoiser and based at least on an input indicating one or more characteristics of a scene, a plurality of estimated views of the scene corresponding to a texture. The one or more circuits can render, from a model of the texture, a plurality of renders of the texture, at least one render of the plurality of renders being associated with a corresponding estimated view of the plurality of estimated views. The one or more circuits can update the model of the texture based at least on the plurality of renders and the plurality of estimated views. The one or more circuits can update the plurality of estimated views based at least on the plurality of renders.

In some implementations, the one or more circuits update the model of the texture based at least on a consistency loss determined according to the plurality of renders and the plurality of estimated views. In some implementations, the denoiser operates in an image space for the scene. In some implementations, the denoiser operates in a latent space, and the one or more circuits use an encoder to convert the plurality of estimated views from the latent space to an image space of the plurality of renders.

In some implementations, the one or more circuits perform a plurality of iterations of updating of the model until a convergence criterion is satisfied, the convergence criterion including at least one of a threshold for the plurality of iterations or a threshold for one or more losses associated with the plurality of estimated views and the plurality of renders. In some implementations, the scene includes an object corresponding to the one or more characteristics. In some implementations, one or more (e.g., each) estimated view(s) of the plurality of estimated views correspond to a different camera perspective of the scene. In some implementations, the model of the texture is a three-dimensional (3D) model including parameters of one or more geographic elements or one or more 3D constructs representing 3D information.

At least one implementation relates to a system including one or more processors to execute operations. The one or more processors can execute operations to cause a denoiser to determine a plurality of estimated views of a scene for which to generate a texture, based at least on an input indicating one or more characteristics of the scene. The one or more processors can execute operations to render, from a model of the texture, a plurality of renders of the texture, at least one render of the plurality of renders associated with a corresponding estimated view of the plurality of estimated views. The one or more processors can execute operations to update the model of the texture based at least on the plurality of renders and the plurality of estimated views. The one or more processors can execute operations to update the plurality of estimated views based at least on the plurality of renders.

In some implementations, the one or more processors executing the operations update the model of the texture based at least on a consistency loss determined according to the plurality of renders and the plurality of estimated views. In some implementations, the denoiser operates in an image space for the scene. In some implementations, the denoiser operates in a latent space, and the one or more processors executing the operations use an encoder to convert the plurality of estimated views from the latent space to an image space of the plurality of renders. In some implementations, the one or more processors executing the operations perform a plurality of iterations of updating of the model until a convergence criterion is satisfied, the convergence criterion including at least one of a threshold for the plurality of iterations or a threshold for one or more losses associated with the plurality of estimated views and the plurality of renders.

In some implementations, the scene includes an object corresponding to the one or more characteristics. In some implementations, at least one estimated view of the plurality of estimated views corresponds to a different camera perspective of the scene. In some implementations, the model of the texture is a three-dimensional (3D) model including parameters of one or more geographic elements or one or more 3D constructs representing 3D information.

At least one implementation relates to a method. The method can include using a denoiser to determine a plurality of estimated views of a scene for which to generate a texture, based at least on an input indicating one or more characteristics of the scene. The method can include rendering, using one or more processors and based on a model of the texture, a plurality of renders of the texture, at least one (e.g., each) render of the plurality of renders associated with a corresponding estimated view of the plurality of estimated views. The method can include updating, using one or more processors, the model of the texture based at least on the plurality of renders and the plurality of estimated views. The method can include updating, using one or more processors, the plurality of estimated views based at least on the plurality of renders.

In some implementations, the method can include updating, using the one or more processors, the model of the texture based at least on a consistency loss determined according to the plurality of renders and the plurality of estimated views. In some implementations, the method can include performing, using the one or more processors, a plurality of iterations of updating of the model until a convergence criterion is satisfied, the convergence criterion including at least one of a threshold for the plurality of iterations or a threshold for one or more losses associated with the plurality of estimated views and the plurality of renders.

The processors, systems, and/or methods described herein can be implemented by or included in at least one a system for performing simulation operations; a system for performing collaborative content creation for 3D assets; a system for generating synthetic data; a system including one or more vision language models (VLMs); a system including one or more large language models (LLMs); a system for performing conversational AI operations; a system for performing light transport simulation; a system for performing deep learning operations; a system for performing digital twin operations; a control system for an autonomous or semi-autonomous machine; a perception system for an autonomous or semi-autonomous machine; a system incorporating one or more virtual machines (VMs); a system implemented using a robot; a system implemented using an edge device; a system implemented at least partially in a data center; or a system implemented at least partially using cloud computing resources.

### BRIEF DESCRIPTION OF THE DRAWINGS

The present systems and methods for texture synthesis via multi-view synchronized denoising and optimization is described in detail below with reference to the attached drawing figures, wherein:

FIG. 1 is a block diagram of an example system to perform operations including texture synthesis, in accordance with some embodiments of the present disclosure;

FIG. 2 depicts a block diagram of an example process showing how texture synthesis occurs using multi-view synchronized denoising and optimization, in accordance with some embodiments of the present disclosure;

FIG. 3 is a flow diagram of an example of a method for performing texture synthesis, in accordance with some embodiments of the present disclosure;

FIG. 4 is a block diagram of an example content streaming system suitable for use in implementing some embodiments of the present disclosure;

FIG. 5 is a block diagram of an example computing device suitable for use in implementing some embodiments of the present disclosure; and

FIG. 6 is a block diagram of an example data center suitable for use in implementing some embodiments of the present disclosure.

### DETAILED DESCRIPTION

This disclosure relates to systems and methods for language-conditioned texture generation for three-dimensional (3D) geometries, utilizing an improved technique that aligns textures with the geometry based on textual descriptions. For example, systems and methods in accordance with the present disclosure facilitate the use of text inputs to inform attributes of a texture, which can be used to configure and/or optimize the texture alignment on a 3D model.

Some techniques for generating textures on 3D models do not support physically based renderings (PBR), and often generate noisy and low-quality textures. This can result in visuals that lack realism and fidelity, and thus may not be useful in applications in gaming, virtual reality, and simulation. Some techniques can also fail to provide high-quality natural textures; while they may utilize PBR parameters, these techniques can fail to achieve a target level of detail and visual appeal. The limitations relate to how these methods handle texture sharpness, alignment, tonal accuracy, and resolution. For example, poor alignment of textures with the underlying 3D geometries can lead to noticeable seams or misalignments, disrupting the continuity of the surface appearance. Tonal accuracy issues can also arise when textures do not accurately reproduce the intended colors and gradients, resulting in unrealistic portrayals of material properties. Additionally, inadequate resolution management can prevent these textures from scaling appropriately across different levels of detail, leading to a loss of quality when viewed up close or from different angles.

Systems and methods in accordance with the present disclosure can allow for improved accuracy and realistic texture mapping on 3D models, such as by using an optimization-conditioned sampling technique. For example, a plurality of texture elements can be generated and aligned with the 3D geometry based on depth-conditioned text-to-image diffusion models. These models can represent the texture features with high sharpness, natural tonality, and appropriate PBR properties.

In some implementations, a plurality of particles (e.g., images representing views of an object and/or a scene) are denoised from a noisy state to an estimated view of the object and/or scene for which to generate a texture, such as to generate a model for the texture of the object and/or scene. A plurality of renders can be rendered from the model, where at least one render is associated with a corresponding view of the plurality of estimated views. The estimated views can each correspond to a different camera perspective of the object and/or scene. The parameters of the model for the texture can be updated based on the estimated views and the renders, such as by determining a 3D consistency loss based on the estimated views and the renders. The renders can be used to perform a drift operation to update the particles, such as by determining at least one of a reconstruction loss or a regularization loss based on the estimated views and the renders to update the particles. The drift operation can facilitate realistic alignment amongst the particles, which in turn can facilitate accuracy and/or realism of the texture model.

In some implementations, the attributes of the textures can be refined using sampling techniques that provide high-quality and consistency in texture rendering. This can be performed for attributes such as alignment, color consistency, and PBR suitability. The attributes can be adjusted based on inputs such as text, facilitating precise alignment of textures with both the 3D geometry and the thematic content of the input text.

The texture mapping method (e.g., the optimized textures) can be used to render images of the 3D model in various manners. For example, a detailed and textured 3D model can be extracted from the initial representations, and can be rendered to meet performance criteria, such as for real-time, or augmented/virtual reality applications. Various objectives can be used to facilitate realistic and efficient texture generation, such as to optimize the texture mapping for visual and performance consistency.

The systems and methods described herein may be used for a variety of purposes, by way of example and without limitation, for enhancing virtual reality experiences, improving augmented reality applications, creating detailed digital twins, and in the development of interactive media and games. Moreover, these methods can improve visual simulations, such as architectural visualization, digital marketing, and film production.

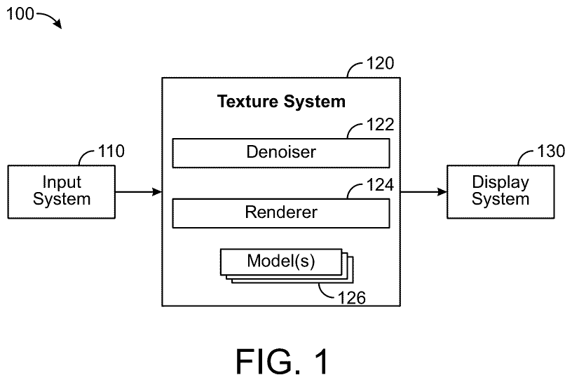

With reference to FIG. 1, an example computing environment including a system for performing operations including texture synthesis is shown, in accordance with some embodiments of the present disclosure. It should be understood that this and other arrangements described herein are set forth only as examples. Other arrangements and elements (e.g., machines, interfaces, functions, orders, groupings of functions, etc.) can be used in addition to or instead of those shown, and some elements can be omitted altogether. Further, many of the elements described herein are functional entities that can be implemented as discrete or distributed components or in conjunction with other components, and in any suitable combination and location. Various functions described herein as being performed by entities can be carried out by hardware, firmware, and/or software. For instance, various functions can be carried out by a processor executing instructions stored in memory.

As described herein, conventional approaches to texture generation are often inadequate. For instance, forward sampling-based methods are good at preserving the quality of synthesized results but are not robust with various geometries. Conversely, reverse sampling methods often lack quality. To address these issues, the texture system 120 can employ an optimization-conditioned sampling technique. This technique can generate initial textures based on depth-conditioned text-to-image diffusion models to capture high-quality details. The system 100 can be used to refine these textures through a drift process that improves alignment and consistency across different geometries. This approach allows the texture system 120 to produce textures that maintain high sharpness, natural tonality, and appropriate PBR properties, ensuring consistency and realism across various views and geometries.

The system 100 is shown as including at least one input system 110, which can be in communication with the texture system 120. The input system 110 can include one or more processors, circuits, memory, and/or computing devices/systems that can perform the various techniques described herein. The input system 110 can include any type of device that is capable of communicating via a network, including but not limited to smartphones, laptop or mobile computers, personal computers, servers, cloud computing systems, or other types of computing systems that can generate or otherwise provide one or more inputs to the texture system 120. The input system 110 can include one or more communications interfaces that facilitate transmission of one or more network packets via the network to one or more external computing systems, which can include the texture system 120.

The input system 110 can receive input data, which may include textual descriptions and/or other forms of input (e.g., and without limitation, image, speech, audio, video and/or gesture) indicating characteristics of a scene. The input data can be provided to the texture system 120, which can process the data to generate textures. The input system 110 can include various input devices or data sources, such as text input interfaces, sensors, or cameras. For example, a user may input a textual description of a scene, specifying details such as lighting, object textures, and colors.

The system 100 is shown as including at least one texture system 120, which can be in communication with the input system 110 and/or display system 130, such as via a network. The texture system 120 can include one or more processors, circuits, memory, and/or computing devices/systems that can perform the various techniques described herein. The texture system 120 can include any type of device that is capable of communicating via a network, including but not limited to smartphones, laptop or mobile computers, personal computers, servers, cloud computing systems, or other types of computing systems that can receive or otherwise identify one or more inputs from input system 110. The texture system 120 can also include any type of device that is capable of generating and refining textures based on inputs. The texture system 120 can include one or more communications interfaces that facilitate transmission of one or more network packets via the network to one or more external computing systems, which can include the input system 110 and/or display system 130. The texture system 120 described herein can be implemented, for example, in a cloud computing environment, which can maintain and execute denoising and rendering operations. As shown, the texture system 120 can include a denoiser 122, a renderer 124, and one or more models 126 used by the renderer 124.

The denoiser 122 can determine a plurality of estimated views of a scene based on the input data. The denoised data can be utilized by the renderer 124. In some implementations, renderer 124 can render a plurality of textures from a model of the texture. For instance, the render can correspond to a different estimated view of the scene. In some implementations, the models 126 of the renderer 124 can be applied to generate textures, employing machine learning algorithms or procedural generation techniques. In some implementations, the renderer 124 can update one or more models 126 of the texture based on the renders and estimated views. Additionally, the plurality of estimated views can be updated by the renderer 124 based on the renders to further refine the texture generation process. In some implementations, when textures are generated, they can be sent to the display system 130. The display system 130 can include various display devices such as monitors, projectors, or virtual reality headsets. The display devices can be used to visualize the textured outputs, providing a clear representation of the scene. The texture system 120, including the denoiser 122 and renderer 124, can use the models 126 (e.g., diffusion model, machine learning algorithms, or procedural techniques). These models can be implemented and trained by various systems within the texture system 120.

Referring to the texture system 120 in greater detail, the texture system 120 can include or be coupled with at least one denoiser system, such as the denoiser 122. The denoiser 122 can determine a plurality of estimated views of a scene for which to generate a texture. For instance, the determination can be based at least on an input indicating one or more characteristics of the scene. That is, the determination can occur during runtime or inference time operations. In some implementations, a diffusion model of models 126 can be used by denoiser 122 to denoise N particles (e.g., data representations that can be processed to generate estimated views of a scene) to time zero. For instance, a diffusion model can be operated based on input (e.g., text input, multimedia input) indicating characteristics for the object and/or scene for which to generate a texture model. Each particle can correspond to a different view or perspective of the scene. For instance, the particles can be initialized in a noisy state and can be progressively refined through denoising steps to achieve clear and accurate representations of the estimated views. In some implementations, the scene can include an object corresponding to the one or more characteristics. For instance, the input can describe a complex scene with multiple objects, facilitating the denoiser 122 to generate multiple views to capture the entire scene. In another instance, the input can specify a single object with various surface details, facilitating the generation of detailed close-up views. In some implementations, at least one estimated view of the plurality of estimated views can correspond to a different camera perspective of the scene. That is, the denoiser 122 can simulate different angles and distances from the scene to create a broad or comprehensive set of views. For instance, the denoiser 122 can generate views from top-down, side, and isometric perspectives to ensure all aspects of the scene are covered.

In some implementations, the denoiser 122 can operate in an image space for the scene. The image space can refer to the pixel-based representation of the scene, where at least one estimated view is processed as a traditional image. For instance, the denoiser 122 can apply image processing techniques directly to these views to enhance and refine them. In some implementations, denoiser 122 can operate in a latent space. That is, the texture system 120 can use an encoder to convert the plurality of estimated views from the latent space to an image space of the plurality of renders. For instance, the encoder can transform high-dimensional image data into a lower-dimensional latent space, to facilitate denoising and other enhancements before converting back to image space for rendering.

The denoiser 122 can initialize a series of particles (e.g., Xₜ particles) which can be a set of images from a plurality of images (e.g., purely noise or all zeros). The particles can be used by the denoiser 122 to determine a plurality of estimated views of a scene. The denoiser 122 can use a diffusion model (e.g., models 126) to perform denoising with K steps (e.g., F(Xₜ,t)). For instance, the diffusion model can predict the X₀ value of the noisy particles, projecting the Xₜ particles to their denoised state X₀ (e.g., X₀ prediction). That is, the denoiser 122 can change the appearance of the particles rather than just removing noise. The renderer 124 can use the X₀ predictions to guide the texture generation process, ensuring that the rendered images align with the predicted outputs. For instance, the denoised particles can be used as intermediate representations for the texture system 120, facilitating the generation of images that closely match the predicted views. By performing the no gradients predictions, the texture system 120 can facilitate the training of a texture model (or another type of renderer model) to generate images by aligning its parameters with the denoised predictions from the diffusion model. That is, the diffusion model of models 126 can be used to denoise and refine the particles to remove noise, and the texture model of models 126 can be used in generating the final high-fidelity textures from the denoised particles. For instance, texture model can apply techniques such as procedural generation or machine learning-based texture synthesis to produce detailed and visually coherent textures that match the predicted views generated by the denoiser 122.

The texture system 120 can also include or be coupled with at least one renderer system, such as the renderer 124. The renderer 124 can render, from a model of the texture, a plurality of renders of the texture. For instance, at least one render of the plurality of renders can be associated with a corresponding estimated view of the plurality of estimated views. That is, textures can be rendered from N views corresponding to the camera perspectives of the N particles. In some implementations, the model used in rendering can be a neural network or any other texture model. For instance, the model of the texture can be parameters including a plurality of triangles in 3D dimensions.

In some implementations, the renderer 124 can update the model (e.g., models 126) of the texture based at least on a consistency loss determined according to the plurality of renders and the plurality of estimated views. That is, the consistency loss can be determined by comparing the rendered images to the X₀ predictions and measuring the discrepancies. For instance, the 3D loss function can be used to calculate this consistency loss. In some implementations, the renderer 124 can perform a plurality of iterations of updating of the model until a convergence criterion is satisfied. That is, the convergence criterion can include at least one of a threshold for the plurality of iterations or a threshold for one or more losses associated with the plurality of estimated views and the plurality of renders. For instance, a threshold for the plurality of iterations can be a specified value below which the loss should fall to consider the process converged.

In some implementations, renderer 124 operates with gradients for multiple iterative operations in 3D space. For instance, the renderer 124 can perform 3D operations iteratively to refine the texture by applying gradients to adjust the model parameters with each iteration. That is, the renderer 124 can update the parameters, which can serve as the model of the texture, based on the gradients determined for each operation. Initially, the parameters, which can include various settings and weights used by the renderer, can be used as input by the renderer 124. The renderer 124 can generate a plurality of renders of the texture from the model of the texture, where at least one render can correspond to an estimated view of the scene. The estimated views can be derived from the N particles, simulating different camera perspectives.

In some implementations, the renderer 124 can also update the model of the texture based at least on the plurality of renders and the plurality of estimated views. For instance, the renderer 124 can use a 3D consistency loss to update the parameters of the texture model. The rendered images produced by the renderer 124 can then evaluated using a 3D loss function (or another function), which can be used to calculate the discrepancy between the rendered images and the X₀ predictions from the denoiser 122 predictions. For instance, the loss can be backpropagated to update the parameters, optimizing them to reduce the loss in subsequent iterations.

In some implementations, the renderer 124 can update the plurality of estimated views based at least on the plurality of renders. For example, the renderer 124 can perform a drift process, such as to cause modification of the estimated views. For example, during the drift process, which can include S steps, the renderer 124 can refine the texture generation. For instance, S steps of drift can refer to iterative adjustments made to improve the consistency and accuracy of the generated textures. To determine when the S steps of drift are satisfied, the texture system 120 can use metrics. For instance, the texture system 120 can determine 3D consistency loss and reconstruction loss combined with regularization loss. The 3D consistency loss (shown above) can measure how well the rendered images align with the expected 3D structure of the scene. As the number of S steps increases, this loss should decrease, indicating improved consistency. The renderer 124 can set a limit on the consistency loss to determine when to stop the drift process. Additionally, the renderer 124 can use the reconstruction loss and regularization loss to ensure that the generated textures are both accurate and adhere to desired properties such as smoothness and continuity. The renderer 124 monitors these losses, and the iteration can stop when any of these metrics meet their respective thresholds. The model used in rendering can be a neural network or any other texture model (e.g., with parameters including a plurality of triangles in 3D dimensions, texture coordinates, or any procedural texture methods).

In some implementations, the renderer 124 can perform drifting with gradients for each view n of N to refine the texture generation. During drifting, particles can be optimized for each view n, ensuring consistency and realism across the generated textures. For instance, X_{t,n} particles can be initialized similarly to the Xₜ particles in denoiser 122. The particles can represent different views of the scene, each associated with a particular camera perspective. The X_{t,n} particles can be subjected to denoising with K steps. For instance, denoiser 122 can denoise using a diffusion model (e.g., F(X_{t,n}, t)). The denoising can remove noise from the particles, producing X_{0,n} that represent denoised versions of the particles. In some implementations, the texture system 120 can compare the denoised particles with the rendered images produced from the 3D parameters of the detached clone, ensuring that the denoising process aligns with the predicted views. The texture system 120 can use the comparison to calculate the regularized loss function, which measures the discrepancy between the X_{0,n} predictions and the rendered images. In some implementations, the loss function can include terms for both reconstruction loss and regularization loss. The texture system 120 improves the accuracy and adheres to desired properties such as smoothness and continuity of the generated textures. For instance, the texture system 120 can use the reconstruction loss to measure how well the generated textures match the expected output. In another instance, texture system 120 can use the regularization loss to ensure that the textures are consistent and realistic across different views. In some implementations, the texture system 120 can backpropagate to update the X_{t,n}.

In some implementations, the drift process can be similar to the texture rendering with gradients but in reverse. That is, instead of starting with rendered images and updating parameters, the drift process can start with denoised particles and the texture system 120 can update the particles themselves. The drift process, which can include S steps, adds another force to the diffusion model, making the generated textures more realistic and consistent with other images. The main contribution of the drift step is the production of ground truth (3D parameters and rendered images) during the texture generation process. By using the drift step, the renderer 124 can pull the particles closer to the average, ensuring that the final rendered textures are consistent and high-fidelity. The loss function is designed to push for consistency hard at the beginning, but towards the end, the diffusion model is used to complete better details, ensuring that the textures are both accurate and realistic.

In some implementations, the drift process operates similarly to the texture rendering with gradients but in reverse. Instead of starting with rendered images and updating parameters, the drift process begins with denoised particles, and the texture system 120 updates the particles themselves. The drift process, including S steps, can apply gradient updates to the diffusion model, ensuring the generated textures maintain consistency with other images. The function of the drift step can be to generate ground truth (e.g., 3D parameters and rendered images) during texture generation. By applying the drift step, the renderer 124 can adjust the particles towards the average, facilitating consistency in the final rendered textures. The loss function can be used to prioritize consistency in the initial stages, while the diffusion model can refine the details in later stages, optimizing texture accuracy and coherence.

The texture system 120 can store or otherwise include at least one model, such as models 126. The models 126 can include at least one diffusion model 126 and at least one texture model 126. In some implementations, the diffusion model can include a network, such as a denoising network (not shown). For example, in brief overview, the diffusion model can include a denoising network that is configured (e.g., pre-trained, trained, updated, fine-tuned, and/or has transfer learning applied) using training data that includes data elements to which noise is applied, and configuring the denoising network to modify the noise-augmented data elements to recover the (un-noised) data elements. The models 126 can include (e.g., the denoising network can be implemented as) a latent diffusion model (LDM). The LDM can include or be coupled with a texture system 120. In some implementations, the texture model can include a network, such as a rendering network (not shown) (or any other neural network used in texture modeling). For example, in brief overview, the texture model can include a rendering network that is configured (e.g., pre-trained, trained, updated, fine-tuned, and/or has transfer learning applied) using training data that includes texture data elements, and configuring the rendering network to generate high-fidelity textures based on the input data elements. The models 126 can include (e.g., the rendering network can be implemented as) a procedural generation model. The procedural generation model can include or be coupled with a texture system 120.

The system 100 is shown as including at least one display system 130, which can be in communication with the texture system 120. The display system 130 can include one or more processors, circuits, memory, and/or computing devices/systems that can perform the various techniques described herein. The display system 130 can include any type of device that is capable of communicating via a network, including but not limited to smartphones, laptop or mobile computers, personal computers, servers, cloud computing systems, or other types of computing systems that can receive or otherwise identify one or more outputs of the texture system 120. The display system 130 can include one or more communications interfaces that facilitate transmission of one or more network packets via the network to one or more external computing systems, which can include the texture system 120.

The display system 130 can include various display devices such as monitors, projectors, or virtual reality headsets. These display devices can be used to visualize the textured outputs generated by the texture system 120, providing a clear representation of the scene. For instance, the display system 130 can render the final textured 3D models, ensuring that the visual output is accurate and consistent with the processed textures. The display system 130 can be configured to handle high-resolution images and support various display formats to accommodate different visualization needs. In some implementations, the display system 130 can operate with high refresh rates and low latency to ensure smooth visualization of dynamic scenes. This can be important for applications such as virtual reality, where the quality of the display can significantly impact the user experience. The display system 130 can also support advanced features such as stereoscopic 3D, which enhances the depth perception and realism of the rendered textures. Additionally, the display system 130 can include interfaces for user interaction, allowing users to manipulate the 3D models and textures in real-time. This can be achieved through input devices such as keyboards, mice, touchscreens, or motion controllers. The interactive capabilities of the display system 130 can allow users to explore different views and perspectives of the textured models.

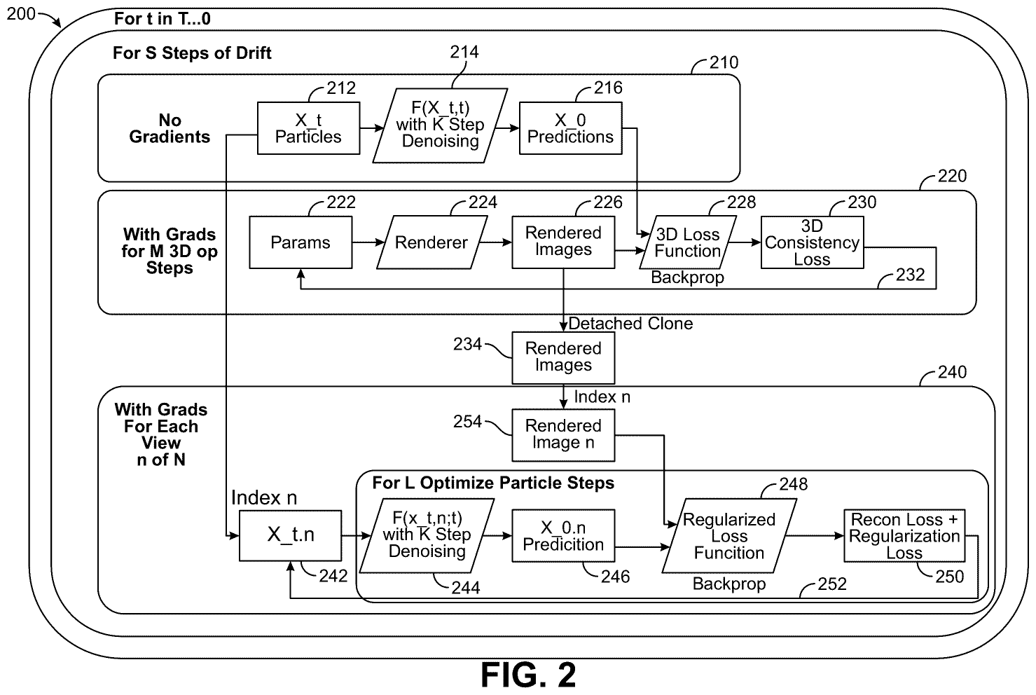

Now referring to FIG. 2, an example process 200 of performing texture synthesis (e.g., using the system 100) using multi-view synchronized denoising and optimization is depicted, in accordance with some embodiments of the present disclosure. The example process 200 can enhance texture generation. The example process 200 can be described with reference to Machine Learning Model Operation Process 1 (shown below):

Machine Learning Model Operation Process 1 Multistep
Operations Overview

```
Sample initial latent particles {X_{T,n} } ~ q_{T}(x)
for t ∈{T . . . 0} do
  $Initialize {X}_{t , n}^{0} = {X}_{t , n}$
  for s ∈{1 . . . S} do
    $Project particles to data space {\hat{X}}_{0 , n}^{s} = {f}_{θ} ( {x}_{t , n}^{s - 1} )$
    Fit 3D representation to particles
    ${z}^{*} = arg {max}_{z ϵ Z} log p ( z \vert \{ {\hat{X}}_{0 , n}^{s} \} )$
      Perform MAP on x_{t,n} with observation z*
    ${x}_{t , n}^{s} = arg max log {p}_{θ} ( {x}_{t , n} \vert {x}_{t + 1 , n} = {x}_{t , n}^{0} , {x}_{0 , n} = ℛ ( {z}^{*} ) )$
  end for
  $Update particles to {x}_{t - 1 , n} from {x}_{t , n}^{s} with the denoiser$
end for
```

where T is the total number of timesteps, X_{T,n} is the initial latent particles, q_{T}(X) is the initial distribution of the latent particles, t is the current timestep,

$${X}_{t , n}^{0}$$

is the initial state of the particles at timestep t, X_{t,n} is the state of the particles at timestep t, s is the current drift step, S is the total number of drift steps,

$${\hat{X}}_{0 , n}^{s}$$

is the projected particle in data space at step s,

$${f}_{θ} ( {X}_{t , n}^{s - 1} )$$

is the projection function parameterized by θ, z* is the optimal 3D representation, z is the set of possible 3D representations,

$${\hat{X}}_{0 , n}^{s}$$

is the projected particle at step s,

$${X}_{t , n}^{s}$$

is the particle state at step s, p_{θ} is the probability distribution parameterized by θ, [symbol] (z*) is the rendered image from the optimal 3D representation, X_{t-1,n} is the updated particle state for the next timestep, and

$${X}_{t , n}^{s}$$

is the particle state at step s.

In some implementations, a Tweedie formula can be used (Equation 1):

$${\hat{x}}_{0} = \frac{{x}_{t} - {σ}_{t} \hat{ϵ} ( {x}_{t} )}{\sqrt{{∝}_{t}}}$$

where Tweedie's formula can be used to estimate x₀ from xₜ with a single diffusion step. In some implementations, a denoising trajectory with a denoising diffusion implicitly model (DDIM) can be used to estimate x₀.

In some implementations, to save on VRAM, f_{θ} can be first run without storing activations in a full batch when projecting particles for 3D consistency updates. This step projects particles to the data space while managing memory resources. Then, f_{θ} can be run in mini-batches with gradients when updating particles. This two-step process can manage available memory by minimizing the VRAM required for initial projections and then applying necessary gradient updates in smaller, manageable batches. This approach balances computational efficiency and memory usage, generating and optimizing high-quality textures without exceeding hardware limitations.

In block 210, the texture system 120 initializes particles without gradients. That is, the texture system 120 can cause a denoiser to determine a plurality of estimated views of a scene for which to generate a texture, based at least on an input indicating one or more characteristics of the scene (e.g., textual descriptions, multimedia inputs, or other data specifying details about the scene or object, such as lighting conditions, surface textures, colors, shapes, and other relevant attributes). In some implementations, the texture system 120 can determine, using a denoiser and based at least on an input indicating one or more characteristics of a scene, a plurality of estimated views of the scene corresponding to a texture. For instance, the projection of particles into the data space can be performed using the function

$${f}_{θ} ( {X}_{t , n}^{s - 1} )$$

(e.g., the projection function parameterized by θ). In some implementations, the system initializes a series of Xₜ particles (e.g., input indicating the one or more characteristics) representing different views. That is, the series of Xₜ particles can represent the initiate state of different views of the scene or object. The characteristics of the scene or object can be encoded within the Xₜ particles. For instance, the texture system 120 can initialize particles from a noisy state for further processing. In another instance, the texture system 120 can prepare these particles to undergo denoising. The initial state of these particles can follow the distribution q_{T}(x) (e.g., the initial distribution of the latent particles). In some implementations, the texture system 120 can fit the 3D representation to produce a well-converged z* (e.g., the optimal 3D representation). This process can involve include gradient steps to ensure convergence. Various alternatives, such as UV materials and spherical projections, can be implemented by the texture system 120 (e.g., provided they render quickly and/or optimize efficiently). Additionally, the texture system 120 can implement a rendering setup, such as using an HDR environment map for lighting cues and adding floors to object-centric meshes for shadows, enhancing the quality since the diffusion model can be trained on such data.

At block 212, the texture system 120 can denoise the Xₜ particles using K step denoising. In some implementations, the denoising is performed by a diffusion model (e.g., F(Xₜ, t)). That is, the model can predict the X₀ value (e.g., generated estimated views) of the noisy particles, projecting the Xₜ particles to their denoised state X₀. After denoising, the X₀ values can represent the denoised particles and the denoised particles can represent various views or perspectives. For instance, the texture system 120 can refine the particles' appearance by reducing noise, making them suitable for further texture synthesis. At block 214, the texture system 120 generates X₀ predictions from the denoised particles. In some implementations, the predictions serve as the basis for subsequent texture rendering. That is, these predictions can provide an improved, noise-free version of the initial particles. For instance, the texture system 120 prepares these predictions for the rendering phase to ensure accurate texture generation (e.g., provide the X₀ predictions to block 228 for loss function analysis). In some implementations, a depth-conditioned super resolution diffusion model can be used to perform super-resolution after generating a texture with the base model in a first round. For instance, renders of the first round can be concatenated with depth to enhance the resolution.

In block 220, the texture system 120 operates with gradients for M 3D operations steps. In some implementations, the texture system 120 renders, from a model (e.g., parameters) of the texture, a plurality of renders of the texture. For instance, at least one render of the plurality of renders can be associated with a corresponding estimated view of the plurality of estimated views. Additionally, the texture system 120, at block 220, can update the model of the texture based at least on the plurality of renders and the plurality of estimated views. That is, the texture system 120, at block 220, can perform M operations of operations in the 3D space. During the operations, gradients can be used to update the model parameters. The updating can cause 3D representations to be refined, improving the accuracy and quality of the generated textures. In some implementations, the system updates the model parameters based on the renders and estimated views. For instance, the texture system 120 uses a 3D loss function to measure the consistency between the rendered images and the X₀ predictions. In another instance, the texture system 120 performs backpropagation to adjust the model parameters, optimizing texture quality. In some implementations, the texture system 120 can alternate between forward time diffusion from t to t+1 and reverse time diffusion to obtain more consistent results.

At block 222, the texture system 120 can use the parameters (e.g., a model of the texture) for rendering. In some implementations, the parameters include various settings and weights that guide the rendering process. That is, the parameters can help the texture system 120 generate high-fidelity textures. For instance, the texture system 120 uses these parameters to render textures that align closely with the predicted views. At block 224, the texture system 120 can render images (e.g., a plurality of renders) from the model of the texture. In some implementations, the rendered images correspond to different estimated views of the scene. That is, the renderer produces multiple images from different camera perspectives (e.g., corresponding estimated views). The corresponding estimated views can be derived from the denoised particles (X₀ predictions). For instance, these rendered images provide a visual representation of the textured scene. At block 226, the texture system 120 can provide the rendered images for analysis using a 3D loss function at block 228. Additionally, the rendered images can also be provided as detached clones to block 234, and subsequently at block 240.

In some implementations, a detached clone of the rendered images can include the same data and rendered images as the main rendering process but without backpropagation. This means that while these images are used for evaluating the final output, they do not contribute to the gradient calculations during the backward pass. The detached clone can be used as a static reference to compare and average the outputs, helping to determine the most agreed-upon view. For instance, the agreed-upon view can be a representation of the 3D object with textures, which can be generated using techniques such as neural radiance fields (NeRF) or Gaussian splatting. In some implementations, NeRF can be used to synthesize consistent images from various perspectives, ensuring that the final rendered textures are coherent. The process can apply a soft constraint. For instance, the rendered images do not need to match exactly but should be consistent throughout the iterations to achieve a high-fidelity result. By utilizing the detached clone, a renderer can ensure that the rendered images are consistently aligned with the predicted views, facilitating the generation of high-quality textures.

At block 228, the loss function can be used to calculate the discrepancy between the rendered images and the X₀ predictions. That is, the loss function can be used to identify areas where the rendered images deviate from the expected outcome. For instance, the texture system 120 can use the loss function output to guide a backpropagation process 232.

The Jacobian of \hat{X}₀ with respect to Xₜ can be (Equation 2):

$${J}_{{\hat{x}}_{0}} ( {X}_{t} ) = \frac{I - {σ}_{t} {J}_{{ϵ}_{θ}} ( {X}_{t} )}{\sqrt{{α}_{t}}}$$

In some implementations, formulating the updates of Xₜ can be performed using a mean drift (Equation 3):

$${\tilde{∇}}_{{x}_{t}} {‖ {\hat{X}}_{0} - R ( {𝓏}^{*} ) ‖}_{2}^{2} = \frac{1 - {σ}_{t}}{\sqrt{{α}_{t}}} ( {\hat{X}}_{0} - R ( {𝓏}^{*} ) )$$

At block 230, the texture system 120 can determine 3D consistency loss. In some implementations, the consistency loss measures how well the rendered images align with the expected 3D structure. That is, the texture system 120 can use the metric to ensure the textures are consistent across different views. For instance, a lower consistency loss can indicate better alignment and higher texture quality. At block 232, the texture system 120 can perform backpropagation based on the 3D consistency loss. In some implementations, the texture system 120 adjusts the model (e.g., parameters) to minimize the loss (e.g., the model can be updated to minimize the loss, refining the texture model to improve alignment and quality of the rendered textures). That is, backpropagation can be used to improve the alignment between the rendered images and the predictions. For instance, this iterative process can refine the texture model to improve output quality. In some implementations, the texture system 120 can continue the iterative process until a convergence criterion is met. For instance, the texture system 120 can stop updating the parameters once the loss falls below a specified threshold. Additionally, at block 234, the texture system 120 can provide a detached clone of the rendered images. In some implementations, the detached clone includes the same data as the main rendering process but without backpropagation. That is, the clone can be a static reference for comparison at block 240.

In block 240, the texture system 120 performs drifting with gradients for each view n of N to refine the texture generation. In some implementations, the texture in each specific view n (out of the total N views) can be refined by drifting the gradients in each view. For instance, if N is 20, then n can be any value from 1 to 20, representing one of those 20 specific perspectives. The particles for each view n can be optimized over L steps, where each step can include refining the particles to improve the texture generation. In some implementations, this can be an iterative process where the particles are denoised, and their appearance is gradually improved over L optimization steps. For instance, the iterative optimization can improve the consistency and quality of the final textures. That is, the texture system 120 can update the plurality of estimated views based at least on the plurality of renders. In some implementations, the texture system 120 can optimize particles for each view n over L steps, where each step can include refining the particles to improve the texture generation. The particles

$${X}_{t , n}^{s}$$

(e.g., the particle state at step s) can be adjusted interactively to enhance their appearance and consistency.

At block 242, the texture system 120 can initialize X_{t,n} particles similarly to the Xₜ particles in block 212 (e.g., where

$${X}_{t , n}^{s}$$

is the particle state at step s). For instance, the texture system 120 can initialize X_{t,n} particles for each view. In some implementations, these particles can represent various angles and distances from the scene. That is, the texture system 120 can prepare the particles for denoising. At block 244, the texture system 120 can denoise the X_{t,n} particles with K step denoising (e.g., F(X_{t,n}, t)—where F is the denoising function applied by the diffusion model, where X_{t,n} is the state of the particle for view n at time t, where t is the time step in the denoising process. In some implementations, the denoising process is performed using a diffusion model. That is, the diffusion model can be used to remove noise from the particles, producing X_{0,n} predictions (e.g., where

$${\hat{X}}_{0 , n}^{s}$$

is the projected particle at step s). For instance, the texture system 120 can cause the denoised particles to align (or closely align) with the expected views. At block 246, the texture system 120 generates the X_{0,n} predictions from the denoised particles.

In some implementations, these predictions are compared with the rendered images produced from the 3D parameters of the detached clone at block 248. This method can be extended to Latent Diffusion Models (LDMs) by translating

$${\hat{X}}_{0 , n}^{s}$$

from latent to RGB space with an autoencoder. An aggregation operation (e.g., a Sequential Interlaced Multiview Sampler (“SIMS”) aggregation) with latent texture maps can further be used to maintain 3D consistency. In some implementations, drifting and SIMS can be combined to enhance texture fidelity. That is, the comparison can be used to calculate the regularized loss function (e.g., where z* is the optimal 3D representation). In some implementations, the Fit 3D step can be inside the particle update loop. In some implementations, a residual of the one-step approximation (ε′ₜ) to weigh the 3D loss relative to the prior loss can be used. Additionally, an inverse-linear scale constant or constant weight can be used for adjusting the influence of the 3D loss relative to the prior loss.

At block 248, the texture system 120 can perform a regularized loss function. In some implementations, the loss function includes terms for both reconstruction loss and regularization loss. The probability distribution p_{θ} (e.g., the probability distribution parameterized by θ) can be used to measure the likelihood of the observed data given the model parameters. That is, the evaluation can measure the discrepancy between the X_{0,n} predictions and the rendered images. At block 250, the texture system 120 can calculate reconstruction loss and regularization loss. In some implementations, the reconstruction loss can measure how well the generated textures match the expected output (e.g., where [symbol] (z*) is the rendered image from the optimal 3D representation). That is, the loss function can be used produce textures that are consistent and realistic across different views. At back propagation 252, the texture system 120 can update the X_{t,n} particles based on the loss evaluation. The updated particles X_{t-1,n} (e.g., the updated particle state for the next timestep In some implementations, the system adjusts the particles to minimize the loss. At block 254, the texture system 120 can generate or provide rendered images n from the optimized particles. In some implementations, these rendered images are compared with the X_{0,n} predictions to verify alignment.

Accordingly, example process 200 provides an improved method for texture synthesis, using a combination of denoising, rendering, and optimization techniques to produce high-quality textures. This approach ensures that the textures are consistent, realistic, and aligned with the expected views, providing an improved technical solution for texture generation in various applications.

In some implementations, Machine Learning Model Operation Process 2 can be used in texture generation (shown below):

Machine Learning Model Operation Process 2 Drift Fusion:
Drifting + TexFusion SIMS

```
Sample initial latent texture map {z_{T}} ~ q_{T}(z)
for t ∈{T . . . 0} do
  iterate over cameras
  for n∈{0, . . . N} do
    $Initialize {x}_{t , n}^{0} = R ( {z}_{t} )$
    Perform drifts
    for s ∈{1 . . . S} do
      $Project particles to data space {\hat{x}}_{0 , n}^{s} = {f}_{θ} ( {X}_{t , n}^{s - 1} )$
      Fit 3D representation to particles
      ${w}^{*} = arg {max}_{w ϵ Z} log p ( w \vert \{ {\hat{X}}_{0 , n}^{s} \} )$
        Perform MAP on X_{t,n} with observation w*
      ${X}_{t , n}^{s} = arg max log {p}_{θ} ( {X}_{t , n} \vert {x}_{t , n}^{0} , ℛ ( {w}^{*} ) )$
    end for
  end for
  Aggregate drift outputs and perform SIMS
  \tilde{z}ₜ = Aggregate(X_{t,n})
  zₜ₋₁ = SIMS(\tilde{z}ₜ)
end for
```

where T is the total number of timesteps, z_{T} is the initial latent texture map, q_{T}(z) is the initial distribution of the latent particles, t is the current timestep,

$${X}_{t , n}^{0}$$

is the initial state of the particles at timestep t, X_{t,n} is the state of the particles at timestep t, s is the current drift step, S is the total number of drift steps,

$${\hat{X}}_{0 , n}^{s}$$

is the projected particle in data space at step s,

$${f}_{θ} ( {X}_{t , n}^{s - 1} )$$

is the projection function parameterized by θ, w* is the optimal 3D representation, z is the set of possible 3D representations,

$${X}_{t , n}^{s}$$

is the particle state at step s, p_{θ} is the probability distribution parameterized by θ, [symbol] (w*) is the rendered image from the optimal 3D representation, z₍ₜ₋₁₎ is the updated particle state for the next timestep, and \tilde{z}ₜ is the aggregated drift output.

Machine Learning Model Operation Process 2 extends Machine Learning Model Operation Process 1 by incorporating multiple camera views and a structured aggregation step. In some implementations, latent texture maps can be initialized and iterated over both timesteps and camera views. The particles can be projected to data space and optimized similarly to Machine Learning Model Operation Process 1, but with the added complexity of handling multiple camera perspectives. After performing drifts for each view, Machine Learning Model Operation Process 2 (implemented by texture system 120) can aggregate the outputs from these multiple views using a SIMS approach to provide consistency across different perspectives. This step is crucial for producing coherent and high-quality textures that are consistent in 3D space.

In some implementations, Machine Learning Model Operation Process 3 can be used in texture generation (shown below):

Machine Learning Model Operation Process 3 High likelihood
Score-Based Diffusion Sampling (SDS)

```
Sample initial 3D rep μ
while not converged do
  Sample xₜ ~ q(Xₜ|X₀ = R(μ))
  for s∈{1 . . . S} do
    $Update {X}_{t} with ∇ {X}_{t} {‖ {f}_{θ} ( {X}_{t} ) - R ( μ ) ‖}_{2}^{2}$
  end for
  $Update μ with SDS or EDS [ {∈}_{θ} ( {X}_{t} ) - \tilde{∈} ] \frac{d R ( μ )}{d μ}$
end while
```

where μ is the initial 3D representation, xₜ is the particle state at time t, q(Xₜ|X₀=R(μ)) is the distribution of particles conditioned on the 3D representation, s is the current drift step, S is the total number of drift steps, f_{θ}(Xₜ) is the projection function parameterized by θ, ∇Xₜ is the gradient of Xₜ, R(μ) which is the rendered image from the 3D representation, ∈_{θ}(Xₜ) is the denoising function parameterized by θ and \tilde{∈} is the estimated noise.

Machine Learning Model Operation Process 3 differs from Machine Learning Model Operation Process 1 in that it use high likelihood SDS. In some implementations, Machine Learning Model Operation Process 3 can be employed in a continuous loop until convergence, facilitating high-likelihood sampling for 3D representation. Initially, the texture system 120 can sample an initial 3D representation, μ. The process can include sampling particles from a distribution conditioned on this 3D representation and iteratively updating the particles and the 3D representation itself. This machine learning model operation process leverages the gradient updates to optimize the particles, followed by updating the 3D representation using SDS and/or Energy-Based Diffusion Sampling (EDS). That is, Machine Learning Model Operation Process 3 extends Machine Learning Model Operation Process 1 by incorporating multiple camera views and a structured aggregation step, facilitating consistency across different perspectives through SIMS. In some implementations, Machine Learning Model Operation Process 3 can be used to emphasize iterative optimization and high-likelihood sampling. It can be used to repeatedly sample particles, performing gradient updates to minimize discrepancies, and refines the 3D representation using diffusion sampling techniques until convergence.

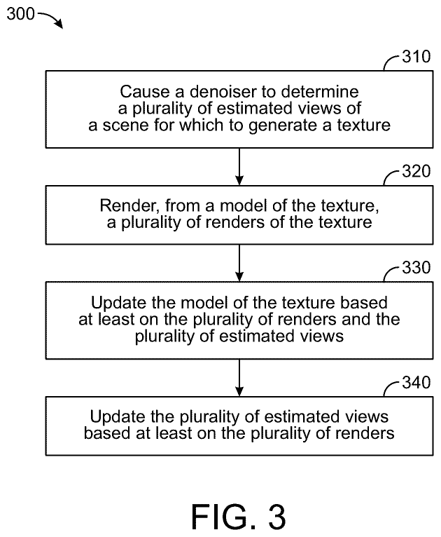

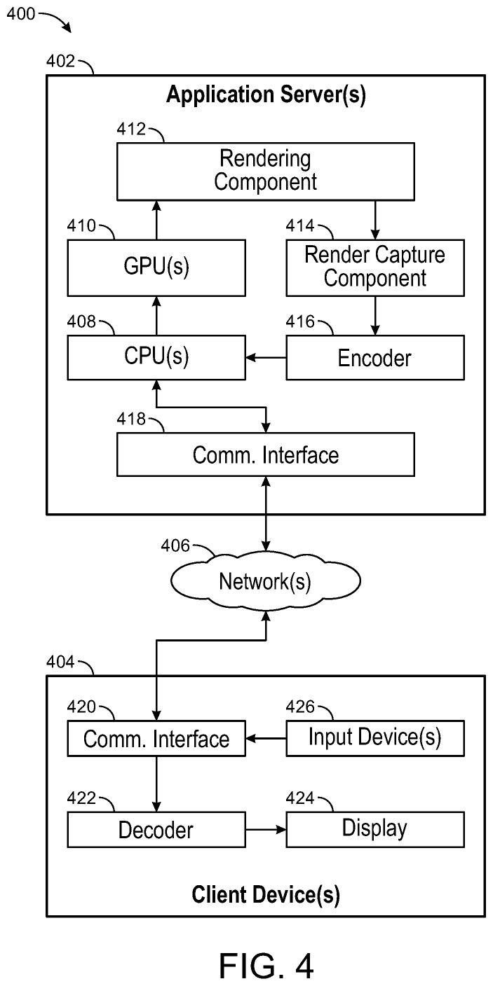

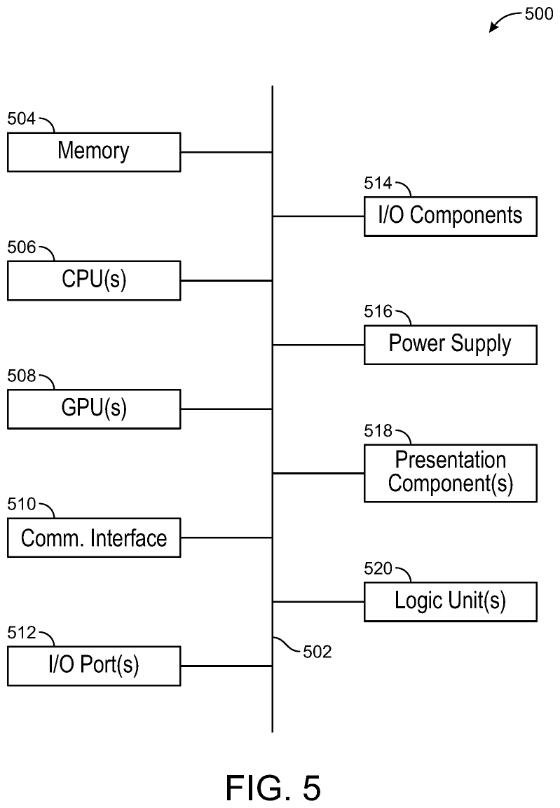

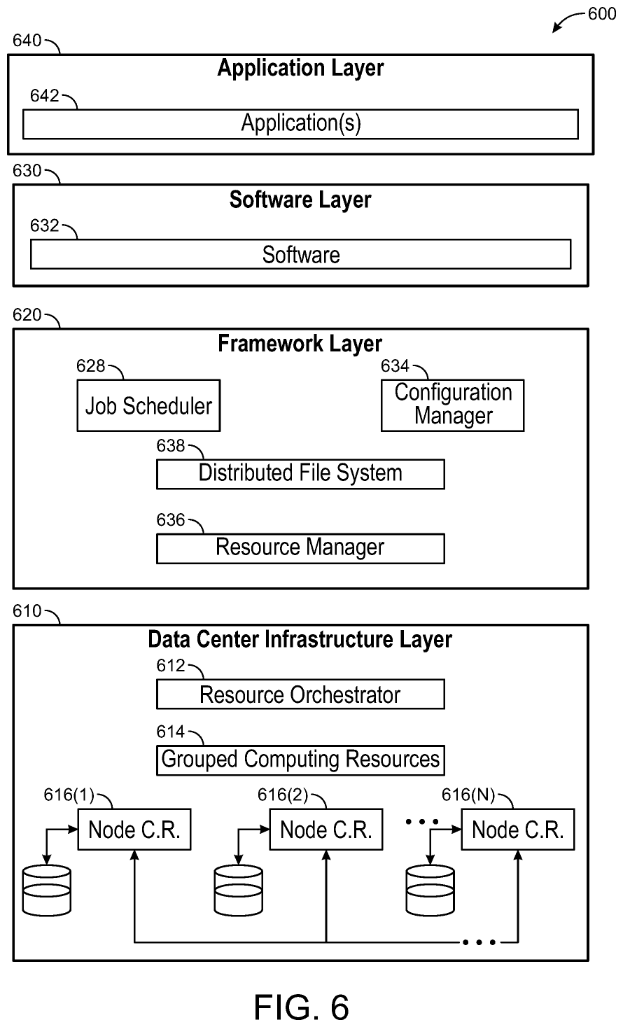

Now referring to FIG. 3, each block of method 300, described herein, includes a computing process that can be performed using any combination of hardware, firmware, and/or software. For instance, various functions can be carried out by a processor executing instructions stored in memory. The method can also be embodied as computer-usable instructions stored on computer storage media. The method can be provided by a standalone application, a service or hosted service (standalone or in combination with another hosted service), or a plug-in to another product, to name a few. In addition, method 300 is described, by way of example, with respect to the systems and architectures of FIG. 1 and FIG. 2. However, this method can additionally or alternatively be executed by any one system, or any combination of systems, including, but not limited to, those described herein. For example, in some implementations, the systems and methods described herein may be implemented using one or more application servers and client devices (e.g., as described in FIG. 4), one or more computing devices (e.g., as described in FIG. 5), and/or one or more data centers (e.g., as described in FIG. 6).

FIG. 3 is a flow diagram showing a method 300 for texture generation and optimization, in accordance with some embodiments of the present disclosure. Various operations of the method 300 can be implemented by the same or different devices or entities at various points in time. For example, one or more first devices can implement operations relating to the initialization and denoising of particles, while one or more second devices can implement operations relating to the rendering and refinement of textures.

Various operations of method 300 can relate to the generation and optimization of textures. Existing systems often are inefficient in generating high-quality textures that are consistent across multiple views. The existing technological problems can arise when attempting to ensure texture consistency and high fidelity in complex geometries. Method 300 and the systems and architectures of FIG. 1 and FIG. 2 can solve the technological problems by employing a combined approach of forward sampling, denoising, and iterative optimization. This method enhances texture synthesis by refining particles through denoising steps, optimizing textures using gradient-based updates, and ensuring consistency across different views through 3D loss functions and backpropagation.

The method 300, at block 310, includes causing a denoiser to determine a plurality of estimated views of a scene for which to generate a texture. For instance, the denoiser can process initial noisy particles to predict clean particles representing various views of the scene. Causing the denoiser to refine the particles' appearance can make them suitable for further texture synthesis. In some implementations (in combination or alternatively), at block 310, the method 300 can determine, using a denoiser and based at least on an input indicating one or more characteristics of a scene, a plurality of estimated views of the scene corresponding to a texture. In some implementations, a diffusion model can be used to denoise N particles to time zero. For instance, the diffusion model can operate based on input (e.g., text input) indicating characteristics for the object and/or scene for which to generate the texture model. That is, the input can provide specific details about the scene, facilitating the prediction by the model to accurately predict particles. In some implementations, estimated views can be determined based at least on an input indicating one or more characteristics of the scene (e.g., lighting conditions, surface textures, colors). For instance, these characteristics can guide the denoising process to ensure the generated textures are accurate. In some implementations, method 300 can be performed during runtime and/or inference time operations. In some implementations, method 300 can implement Machine Learning Model Operation Processes 1, 2, and/or 3 at blocks 310-340.

In some implementations, the denoiser can operate in an image space for the scene. That is, the denoiser can operate in image space rather than latent space. This operation can occur because image space processing can directly refine pixel-level details. For instance, operating in the image space rather than the latent space can enhance the resolution and fidelity of the textures. Additionally, the denoiser can operate in a latent space. For instance, the one or more circuits can use an encoder to convert the plurality of estimated views from the latent space to an image space of the plurality of renders. For instance, to implement method 300 with latent diffusion models (LDMs), the one or more circuits can use an (auto)encoder to translate particles from latent space to image space. In some implementations, the scene can include an object corresponding to the one or more characteristics (e.g., specific geometric shapes, unique texture patterns, distinctive color schemes). For instance, the texture can be generated for an object. In some implementations, at least one estimated view of the plurality of estimated views corresponds to a different camera perspective of the scene. For instance, the denoiser can generate views from various angles to provide various texture coverage.

The method 300, at block 320, includes rendering, from a model of the texture, a plurality of renders of the texture. In some implementations, the textures can be rendered from N views corresponding to the camera perspectives of the N particles. For instance, the model can include parameters including geometric elements and/or 3D constructs. That is, the parameters can be a neural network or any other texture model (e.g., procedural texture methods, machine learning algorithms/operations/processes, physically-based rendering properties). During rendering the one or more circuits can use these parameters to generate accurate and high-fidelity textures. The render of the plurality of renders can be associated with a corresponding estimated view of the plurality of estimated views. For instance, at least one render can be matched to its respective view. In some implementations, the model of the texture can be a three-dimensional (3D) model including parameters of one or more geographic elements or one or more 3D constructs representing 3D information.

The method 300, at block 330, includes updating the model of the texture based at least on the plurality of renders and the plurality of estimated views. That is, 3D consistency loss can be used to perform texture model updating. In some implementations, 3D consistency loss can be used to update the parameters of the texture model (e.g., to align renders with estimated views, to correct texture deviations, to refine geometric accuracy). For instance, the loss function can measure and minimize discrepancies between the rendered images and the estimated views. The updating process can iteratively adjust the model to enhance texture fidelity and consistency.

In some implementations, updating the model of the texture can be based on at least on a consistency loss determined according to the plurality of renders and the plurality of estimated views. For instance, the model can be updated based on the consistency loss determined according to the plurality of renders by adjusting parameters to reduce discrepancies. In another instance, the model can be updated based on the plurality of estimated views by aligning the texture with the predicted camera perspectives.

In some implementations, the method, at block 330, includes performing a plurality of iterations of updating of the model until a convergence criterion is satisfied. For instance, the convergence criterion can include at least one of a threshold for the plurality of iterations (e.g., number of update cycles, iterations count, convergence rate) or a threshold for one or more losses associated with the plurality of estimated views and the plurality of renders (e.g., 3D consistency loss, reconstruction loss, regularization loss). That is, the texture model configuration can be completed based on a number of iterations or any one or more of 3D consistency loss, recon loss, or regularization loss falling below a respective threshold, etc. For instance, the iterative updates continue until the loss metrics indicate high texture fidelity. In another instance, the process stops when predefined criteria are met.

The method 300, at block 340, includes updating the plurality of estimated views based at least on the plurality of renders. Updating can include performing drifting with gradients for each (or at least one) view n of N to refine the texture generation. That is, updating ensures the textures are optimized for all views. In some implementations, the drift can be performed on the same particles that are initially generated in the white box. For instance, the initial particles undergo refinement through gradient-based updates. In some implementations, the diffusion model can newly generate the particles for the drift step. For instance, new particles can be introduced for at least one drift cycle to maintain high texture quality.

### Example Content Streaming System

Now referring to FIG. 4, FIG. 4 is an example system diagram for a texturing system 400, in accordance with some embodiments of the present disclosure. FIG. 4 includes application server(s) 402 (which can include similar components, features, and/or functionality to the example texture system 120 of FIGS. 1-2), client device(s) 404 (which can include similar components, features, and/or functionality to the example computing device 500 of FIG. 5), and network(s) 406 (which can be similar to the network(s) described herein). In some implementations of the present disclosure, the system 400 can be implemented to perform model training/updating and runtime operations. The application session can correspond to a game streaming application (e.g., NVIDIA GeFORCE NOW), a remote desktop application, a simulation application (e.g., autonomous or semi-autonomous vehicle simulation), computer aided design (CAD) applications, virtual reality (VR) and/or augmented reality (AR) streaming applications, deep learning applications, and/or other application types. For example, the system 400 can be implemented to receive input indicating one or more features of output to be generated using a neural network model, provide the input to the model to cause the model to generate the output, and use the output for various operations such as display or simulation operations.

In the system 400, for an application session, the client device(s) 404 can only receive input data in response to inputs to the input device(s), transmit the input data to the application server(s) 402, receive encoded display data from the application server(s) 402, and display the display data on the display 424. As such, the more computationally intense computing and processing is offloaded to the application server(s) 402 (e.g., rendering—in particular ray or path tracing—for graphical output of the application session is executed by the GPU(s) of the game server(s) 402). In other words, the application session is streamed to the client device(s) 404 from the application server(s) 402, thereby reducing the requirements of the client device(s) 404 for graphics processing and rendering.

For example, with respect to an instantiation of an application session, a client device 404 can be displaying a frame of the application session on the display 424 based on receiving the display data from the application server(s) 402. The client device 404 can receive an input to one of the input device(s) and generate input data in response, such as to provide prompts as input for generation of 3D avatars. The client device 404 can transmit the input data to the application server(s) 402 via the communication interface 420 and over the network(s) 406 (e.g., the Internet—Web2 or Web3), and the application server(s) 402 can receive the input data via the communication interface 418. The CPU(s) can receive the input data, process the input data, and transmit data to the GPU(s) that causes the GPU(s) to generate a rendering of the application session. For example, the input data can be representative of a movement or animation of a character of the user in a game session of a game application, firing a weapon, reloading, passing a ball, turning a vehicle, etc. The rendering component 412 can render the application session (e.g., representative of the result of the input data) and the render capture component 414 can capture the rendering of the application session as display data (e.g., as image data capturing the rendered frame of the application session). The rendering of the application session can include ray or path-traced lighting and/or shadow effects, computed using one or more parallel processing units—such as GPUs, which can further employ the use of one or more dedicated hardware accelerators or processing cores to perform ray or path-tracing techniques—of the application server(s) 402. In some implementations, one or more virtual machines (VMs)—e.g., including one or more virtual components, such as vGPUs, vCPUs, etc.—can be used by the application server(s) 402 to support the application sessions. The encoder 416 can then encode the display data to generate encoded display data and the encoded display data can be transmitted to the client device 404 over the network(s) 406 via the communication interface 418. The client device 404 can receive the encoded display data via the communication interface 420 and the decoder 422 can decode the encoded display data to generate the display data. The client device 404 can then display the display data via the display 424.

### Example Computing Device

FIG. 5 is a block diagram of an example computing device(s) 500 suitable for use in implementing some embodiments of the present disclosure. Computing device 500 can include an interconnect system 502 that directly or indirectly couples the following devices: memory 504, one or more central processing units (CPUs) 506, one or more graphics processing units (GPUs) 508, a communication interface 510, input/output (I/O) ports 512, input/output components 514, a power supply 516, one or more presentation components 518 (e.g., display(s)), and one or more logic units 520. In at least one embodiment, the computing device(s) 500 can include one or more virtual machines (VMs), and/or any of the components thereof can include virtual components (e.g., virtual hardware components). For non-limiting examples, one or more of the GPUs 508 can include one or more vGPUs, one or more of the CPUs 506 can include one or more vCPUs, and/or one or more of the logic units 520 can include one or more virtual logic units. As such, a computing device(s) 500 can include discrete components (e.g., a full GPU dedicated to the computing device 500), virtual components (e.g., a portion of a GPU dedicated to the computing device 500), or a combination thereof.

Although the various blocks of FIG. 5 are shown as connected via the interconnect system 502 with lines, this is not intended to be limiting and is for clarity only. For example, in some implementations, a presentation component 518, such as a display device, can be considered an I/O component 514 (e.g., if the display is a touch screen). As another example, the CPUs 506 and/or GPUs 508 can include memory (e.g., the memory 504 can be representative of a storage device in addition to the memory of the GPUs 508, the CPUs 506, and/or other components). In other words, the computing device of FIG. 5 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 5.

The interconnect system 502 can represent one or more links or busses, such as an address bus, a data bus, a control bus, or a combination thereof. The interconnect system 502 can be arranged in various topologies, including but not limited to bus, star, ring, mesh, tree, or hybrid topologies. The interconnect system 502 can include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some implementations, there are direct connections between components. As an example, the CPU 506 can be directly connected to the memory 504. Further, the CPU 506 can be directly connected to the GPU 508. Where there is direct, or point-to-point connection between components, the interconnect system 502 can include a PCIe link to carry out the connection. In these examples, a PCI bus need not be included in the computing device 500.

The memory 504 can include any of a variety of computer-readable media. The computer-readable media can be any available media that can be accessed by the computing device 500. The computer-readable media can include both volatile and nonvolatile media, and removable and non-removable media. By way of example, and not limitation, the computer-readable media can include computer-storage media and communication media.

The computer-storage media can include both volatile and nonvolatile media and/or removable and non-removable media implemented in any method or technology for storage of information such as computer-readable instructions, data structures, program modules, and/or other data types. For example, the memory 504 can store computer-readable instructions (e.g., that represent a program(s) and/or a program element(s), such as an operating system. Computer-storage media can include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, quantum memories, or any other medium which can be used to store the desired information and which can be accessed by computing device 500. As used herein, computer storage media does not include signals per se.

The computer storage media can embody computer-readable instructions, data structures, program modules, and/or other data types in a modulated data signal such as a carrier wave or other transport mechanism and includes any information delivery media. The term “modulated data signal” can refer to a signal that has one or more of its characteristics set or changed in such a manner as to encode information in the signal. By way of example, and not limitation, the computer storage media can include wired media such as a wired network or direct-wired connection, and wireless media such as acoustic, RF, infrared and other wireless media. Combinations of any of the above should also be included within the scope of computer-readable media.

The CPU(s) 506 can be configured to execute at least some of the computer-readable instructions to control one or more components of the computing device 500 to perform one or more of the methods and/or processes described herein. The CPU(s) 506 can each include one or more cores (e.g., one, two, four, eight, twenty-eight, seventy-two, etc.) that are capable of handling a multitude of software threads simultaneously. The CPU(s) 506 can include any type of processor, and can include different types of processors depending on the type of computing device 500 implemented (e.g., processors with fewer cores for mobile devices and processors with more cores for servers). For example, depending on the type of computing device 500, the processor can be an Advanced RISC Machines (ARM) processor implemented using Reduced Instruction Set Computing (RISC) or an x86 processor implemented using Complex Instruction Set Computing (CISC). The computing device 500 can include one or more CPUs 506 in addition to one or more microprocessors or supplementary co-processors, such as math co-processors.

In addition to or alternatively from the CPU(s) 506, the GPU(s) 508 can be configured to execute at least some of the computer-readable instructions to control one or more components of the computing device 500 to perform one or more of the methods and/or processes described herein. One or more of the GPU(s) 508 can be an integrated GPU (e.g., with one or more of the CPU(s) 506 and/or one or more of the GPU(s) 508 can be a discrete GPU. In embodiments, one or more of the GPU(s) 508 can be a coprocessor of one or more of the CPU(s) 506. The GPU(s) 508 can be used by the computing device 500 to render graphics (e.g., 3D graphics) or perform general purpose computations. For example, the GPU(s) 508 can be used for General-Purpose computing on GPUs (GPGPU). The GPU(s) 508 can include hundreds or thousands of cores that are capable of handling hundreds or thousands of software threads simultaneously. The GPU(s) 508 can generate pixel data for output images in response to rendering commands (e.g., rendering commands from the CPU(s) 506 received via a host interface). The GPU(s) 508 can include graphics memory, such as display memory, for storing pixel data or any other suitable data, such as GPGPU data. The display memory can be included as part of the memory 504. The GPU(s) 508 can include two or more GPUs operating in parallel (e.g., via a link). The link can directly connect the GPUs (e.g., using NVLINK) or can connect the GPUs through a switch (e.g., using NVSwitch). When combined together, each GPU 508 can generate pixel data or GPGPU data for different portions of an output or for different outputs (e.g., a first GPU for a first image and a second GPU for a second image). Each GPU can include its own memory, or can share memory with other GPUs.

In addition to or alternatively from the CPU(s) 506 and/or the GPU(s) 508, the logic unit(s) 520 can be configured to execute at least some of the computer-readable instructions to control one or more components of the computing device 500 to perform one or more of the methods and/or processes described herein. In embodiments, the CPU(s) 506, the GPU(s) 508, and/or the logic unit(s) 520 can discretely or jointly perform any combination of the methods, processes and/or portions thereof. One or more of the logic units 520 can be part of and/or integrated in one or more of the CPU(s) 506 and/or the GPU(s) 508 and/or one or more of the logic units 520 can be discrete components or otherwise external to the CPU(s) 506 and/or the GPU(s) 508. In embodiments, one or more of the logic units 520 can be a coprocessor of one or more of the CPU(s) 506 and/or one or more of the GPU(s) 508.

Examples of the logic unit(s) 520 include one or more processing cores and/or components thereof, such as Data Processing Units (DPUs), Tensor Cores (TCs), Tensor Processing Units (TPUs), Pixel Visual Cores (PVCs), Vision Processing Units (VPUs), Image Processing Units (IPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 510 can include one or more receivers, transmitters, and/or transceivers that allow the computing device 500 to communicate with other computing devices via an electronic communication network, included wired and/or wireless communications. The communication interface 510 can include components and functionality to allow communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 520 and/or communication interface 510 can include one or more data processing units (DPUs) to transmit data received over a network and/or through interconnect system 502 directly to (e.g., a memory of) one or more GPU(s) 508. In some implementations, a plurality of computing devices 500 or components thereof, which can be similar or different to one another in various respects, can be communicatively coupled to transmit and receive data for performing various operations described herein, such as to facilitate latency reduction.

The I/O ports 512 can allow the computing device 500 to be logically coupled to other devices including the I/O components 514, the presentation component(s) 518, and/or other components, some of which can be built in to (e.g., integrated in) the computing device 500. Illustrative I/O components 514 include a microphone, mouse, keyboard, joystick, game pad, game controller, satellite dish, scanner, printer, wireless device, etc. The I/O components 514 can provide a natural user interface (NUI) that processes air gestures, voice, or other physiological inputs generated by a user, such as to generate a prompt, image data, and/or video data. In some instances, inputs can be transmitted to an appropriate network element for further processing, such as to modify and register images. An NUI can implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 500. The computing device 500 can be include depth cameras, such as stereoscopic camera systems, infrared camera systems, RGB camera systems, touchscreen technology, and combinations of these, for gesture detection and recognition. Additionally, the computing device 500 can include accelerometers or gyroscopes (e.g., as part of an inertia measurement unit (IMU)) that allow detection of motion. In some examples, the output of the accelerometers or gyroscopes can be used by the computing device 500 to render immersive augmented reality or virtual reality.

The power supply 516 can include a hard-wired power supply, a battery power supply, or a combination thereof. The power supply 516 can provide power to the computing device 500 to allow the components of the computing device 500 to operate.

The presentation component(s) 518 can include a display (e.g., a monitor, a touch screen, a television screen, a heads-up-display (HUD), other display types, or a combination thereof), speakers, and/or other presentation components. The presentation component(s) 518 can receive data from other components (e.g., the GPU(s) 508, the CPU(s) 506, DPUs, etc.), and output the data (e.g., as an image, video, sound, etc.).

### Example Data Center

FIG. 6 illustrates an example data center 600 that can be used in at least one embodiments of the present disclosure, such as to implement the system 100 and/or the process 200 in one or more examples of the data center 600. The data center 600 can include a data center infrastructure layer 610, a framework layer 620, a software layer 630, and/or an application layer 640.

As shown in FIG. 6, the data center infrastructure layer 610 can include a resource orchestrator 612, grouped computing resources 614, and node computing resources (“node C.R.s”) 616(1)-616(N), where “N” represents any whole, positive integer. In at least one embodiment, node C.R.s 616(1)-616(N) can include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some implementations, one or more node C.R.s from among node C.R.s 616(1)-616(N) can correspond to a server having one or more of the above-mentioned computing resources. In addition, in some implementations, the node C.R.s 616(1)-616(N) can include one or more virtual components, such as vGPUs, vCPUs, and/or the like, and/or one or more of the node C.R.s 616(1)-616(N) can correspond to a virtual machine (VM).

In at least one embodiment, grouped computing resources 614 can include separate groupings of node C.R.s 616 housed within one or more racks (not shown), or many racks housed in data centers at various geographical locations (also not shown). Separate groupings of node C.R.s 616 within grouped computing resources 614 can include grouped compute, network, memory or storage resources that can be configured or allocated to support one or more workloads. In at least one embodiment, several node C.R.s 616 including CPUs, GPUs, DPUs, and/or other processors can be grouped within one or more racks to provide compute resources to support one or more workloads. The one or more racks can also include any number of power modules, cooling modules, and/or network switches, in any combination.

The resource orchestrator 612 can configure or otherwise control one or more node C.R.s 616(1)-616(N) and/or grouped computing resources 614. In at least one embodiment, resource orchestrator 612 can include a software design infrastructure (SDI) management entity for the data center 600. The resource orchestrator 612 can include hardware, software, or some combination thereof.

In at least one embodiment, as shown in FIG. 6, framework layer 620 can include a job scheduler 628, a configuration manager 634, a resource manager 636, and/or a distributed file system 638. The framework layer 620 can include a framework to support software 632 of software layer 630 and/or one or more application(s) 642 of application layer 640. The software 632 or application(s) 642 can respectively include web-based service software or applications, such as those provided by Amazon Web Services, Google Cloud and Microsoft Azure. The framework layer 620 can be, but is not limited to, a type of free and open-source software web application framework such as Apache Spark™ (hereinafter “Spark”) that can utilize distributed file system 638 for large-scale data processing (e.g., “big data”). In at least one embodiment, job scheduler 628 can include a Spark driver to facilitate scheduling of workloads supported by various layers of data center 600. The configuration manager 634 can be capable of configuring different layers such as software layer 630 and framework layer 620 including Spark and distributed file system 638 for supporting large-scale data processing. The resource manager 636 can be capable of managing clustered or grouped computing resources mapped to or allocated for support of distributed file system 638 and job scheduler 628. In at least one embodiment, clustered or grouped computing resources can include grouped computing resource 614 at data center infrastructure layer 610. The resource manager 636 can coordinate with resource orchestrator 612 to manage these mapped or allocated computing resources.

In at least one embodiment, software 632 included in software layer 630 can include software used by at least portions of node C.R.s 616(1)-616(N), grouped computing resources 614, and/or distributed file system 638 of framework layer 620. One or more types of software can include, but are not limited to, Internet web page search software, e-mail virus scan software, database software, and streaming video content software.

In at least one embodiment, application(s) 642 included in application layer 640 can include one or more types of applications used by at least portions of node C.R.s 616(1)-616(N), grouped computing resources 614, and/or distributed file system 638 of framework layer 620. One or more types of applications can include, but are not limited to, any number of a genomics application, a cognitive compute, and a machine learning application, including training/updating or inferencing software, machine learning framework software (e.g., PyTorch, TensorFlow, Caffe, etc.), and/or other machine learning applications used in conjunction with one or more embodiments, such as to train, configure, update, and/or execute machine learning models.

In at least one embodiment, any of configuration manager 634, resource manager 636, and resource orchestrator 612 can implement any number and type of self-modifying actions based on any amount and type of data acquired in any technically feasible fashion. Self-modifying actions can relieve a data center operator of data center 600 from making possibly bad configuration decisions and possibly avoiding underutilized and/or poor performing portions of a data center.

The data center 600 can include tools, services, software or other resources to train/update one or more machine learning models (e.g., train/update machine learning models) or predict or infer information using one or more machine learning models (e.g., to generate a large language model) according to one or more embodiments described herein. For example, a machine learning model(s) can be trained/updated by calculating weight parameters according to a neural network architecture using software and/or computing resources described above with respect to the data center 600. In at least one embodiment, trained/updated or deployed machine learning models corresponding to one or more neural networks can be used to infer or predict information using resources described above with respect to the data center 600 by using weight parameters calculated through one or more training/updating techniques, such as but not limited to those described herein.

In at least one embodiment, the data center 600 can use CPUs, application-specific integrated circuits (ASICs), GPUs, FPGAs, and/or other hardware (or virtual compute resources corresponding thereto) to perform training/updating and/or inferencing using above-described resources. Moreover, one or more software and/or hardware resources described above can be configured as a service to allow users to train/update or perform inferencing of information, such as image recognition, speech recognition, or other artificial intelligence services.

### Example Network Environments

Network environments suitable for use in implementing embodiments of the disclosure can include one or more client devices, servers, network attached storage (NAS), other backend devices, and/or other device types. The client devices, servers, and/or other device types (e.g., each device) can be implemented on one or more instances of the computing device(s) 500 of FIG. 5—e.g., each device can include similar components, features, and/or functionality of the computing device(s) 500. In addition, where backend devices (e.g., servers, NAS, etc.) are implemented, the backend devices can be included as part of a data center 600, an example of which is described in more detail herein with respect to FIG. 6.

Components of a network environment can communicate with each other via a network(s), which can be wired, wireless, or both. The network can include multiple networks, or a network of networks. By way of example, the network can include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) can provide wireless connectivity.

Compatible network environments can include one or more peer-to-peer network environments—in which case a server cannot be included in a network environment—and one or more client-server network environments—in which case one or more servers can be included in a network environment. In peer-to-peer network environments, functionality described herein with respect to a server(s) can be implemented on any number of client devices.

In at least one embodiment, a network environment can include one or more cloud-based network environments, a distributed computing environment, a combination thereof, etc. A cloud-based network environment can include a framework layer, a job scheduler, a resource manager, and a distributed file system implemented on one or more of servers, which can include one or more core network servers and/or edge servers. A framework layer can include a framework to support software of a software layer and/or one or more application(s) of an application layer. The software or application(s) can respectively include web-based service software or applications. In embodiments, one or more of the client devices can use the web-based service software or applications (e.g., by accessing the service software and/or applications via one or more application programming interfaces (APIs)). The framework layer can be, but is not limited to, a type of free and open-source software web application framework such as that can use a distributed file system for large-scale data processing (e.g., “big data”).

A cloud-based network environment can provide cloud computing and/or cloud storage that carries out any combination of computing and/or data storage functions described herein (or one or more portions thereof). Any of these various functions can be distributed over multiple locations from central or core servers (e.g., of one or more data centers that can be distributed across a state, a region, a country, the globe, etc.). If a connection to a user (e.g., a client device) is relatively close to an edge server(s), a core server(s) can designate at least a portion of the functionality to the edge server(s). A cloud-based network environment can be private (e.g., limited to a single organization), can be public (e.g., available to many organizations), and/or a combination thereof (e.g., a hybrid cloud environment).

The client device(s) can include at least some of the components, features, and functionality of the example computing device(s) 500 described herein with respect to FIG. 5. By way of example and not limitation, a client device can be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, a holographic display, a biometric authentication device, a quantum computing device, a neuroenhancement headset, an augmented reality glasses, any combination of these delineated devices, or any other suitable device.

The disclosure can be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure can be practiced in a variety of system configurations, including hand-held devices, consumer electronics, general-purpose computers, more specialty computing devices, etc. The disclosure can also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” can include only element A, only element B, only element C, element A and element B, element A and element C, element B and element C, or elements A, B, and C. In addition, “at least one of element A or element B” can include at least one of element A, at least one of element B, or at least one of element A and at least one of element B. Further, “at least one of element A and element B” can include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” can be used herein to connote different elements of methods employed. the terms should not be interpreted as implying any particular order among or between various steps herein disclosed unless and except when the order of individual steps is explicitly described.

What is claimed is:

1. One or more processors comprising:
one or more circuits to:
determine, using a denoiser and based at least on an input indicating one or more characteristics of a scene, a plurality of estimated views of the scene corresponding to a texture;
render, from a model of the texture, a plurality of renders of the texture, at least one render of the plurality of renders being associated with a corresponding estimated view of the plurality of estimated views;
update the model of the texture based at least on the plurality of renders and the plurality of estimated views; and
update the plurality of estimated views based at least on the plurality of renders.

2. The one or more processors of claim 1, wherein the one or more circuits are to update the model of the texture based at least on a consistency loss determined according to the plurality of renders and the plurality of estimated views.

3. The one or more processors of claim 1, wherein the denoiser operates in an image space for the scene.

4. The one or more processors of claim 1, wherein the denoiser operates in a latent space, and the one or more circuits are to use an encoder to convert the plurality of estimated views from the latent space to an image space of the plurality of renders.

5. The one or more processors of claim 1, wherein the one or more circuits are to update the model over a plurality of iterations until a convergence criterion is satisfied, the convergence criterion comprising at least one of a threshold for the plurality of iterations or a threshold for one or more losses associated with the plurality of estimated views and the plurality of renders.

6. The one or more processors of claim 1, wherein the scene comprises an object corresponding to the one or more characteristics.

7. The one or more processors of claim 1, wherein at least one estimated view of the plurality of estimated views corresponds to a different camera perspective of the scene.

8. The one or more processors of claim 1, wherein the model of the texture is a three-dimensional (3D) model comprising parameters of one or more geographic elements or one or more 3D constructs representing 3D information.

9. The one or more processors of claim 1, wherein the one or more processors are comprised in at least one of:
a system for performing simulation operations;
a system for performing collaborative content creation for 3D assets;
a system for generating synthetic data;
a system comprising one or more vision language models (VLMs);
a system comprising one or more large language models (LLMs);
a system for performing conversational AI operations;
a system for performing light transport simulation;
a system for performing deep learning operations;
a system for performing digital twin operations;
a control system for an autonomous or semi-autonomous machine;
a perception system for an autonomous or semi-autonomous machine;
a system incorporating one or more virtual machines (VMs);
a system implemented using a robot;
a system implemented using an edge device;
a system implemented at least partially in a data center; or
a system implemented at least partially using cloud computing resources.

10. A system comprising:
one or more processors to execute operations comprising:
cause a denoiser to determine a plurality of estimated views of a scene based at least on an input indicating one or more characteristics of the scene;
render, from a model of a texture, a plurality of renders of the texture, at least one render of the plurality of renders associated with a corresponding estimated view of the plurality of estimated views;
update the model of the texture based at least on the plurality of renders and the plurality of estimated views; and
update the plurality of estimated views based at least on the plurality of renders.

11. The system of claim 10, wherein the one or more processors executing the operations update the model of the texture based at least on a consistency loss determined according to the plurality of renders and the plurality of estimated views.

12. The system of claim 10, wherein the denoiser operates in an image space for the scene.

13. The system of claim 10, wherein the denoiser operates in a latent space, and the one or more processors executing the operations use an encoder to convert the plurality of estimated views from the latent space to an image space of the plurality of renders.

14. The system of claim 10, wherein the one or more processors executing the operations perform a plurality of iterations of updating of the model until a convergence criterion is satisfied, the convergence criterion comprising at least one of a threshold for the plurality of iterations or a threshold for one or more losses associated with the plurality of estimated views and the plurality of renders.

15. The system of claim 10, wherein the scene comprises an object corresponding to the one or more characteristics.

16. The system of claim 10, wherein at least one estimated view of the plurality of estimated views corresponds to a different camera perspective of the scene.

17. The system of claim 10, wherein the model of the texture is a three-dimensional (3D) model comprising parameters of one or more geographic elements or one or more 3D constructs representing 3D information.

18. A method, comprising:
causing, using one or more processors, a denoiser to determine a plurality of estimated views of a scene based at least on an input indicating one or more characteristics of the scene;
rendering, using the one or more processors from a model of a texture, a plurality of renders of the texture, at least one render of the plurality of renders associated with a corresponding estimated view of the plurality of estimated views;
updating, using one or more processors, the model of the texture based at least on the plurality of renders and the plurality of estimated views; and
updating, using one or more processors, the plurality of estimated views based at least on the plurality of renders.

19. The method of claim 18, further comprising updating, using the one or more processors, the model of the texture based at least on a consistency loss determined according to the plurality of renders and the plurality of estimated views.

20. The method of claim 18, further comprising performing, using the one or more processors, a plurality of iterations of updating of the model until a convergence criterion is satisfied, the convergence criterion comprising at least one of a threshold for the plurality of iterations or a threshold for one or more losses associated with the plurality of estimated views and the plurality of renders.
